(19) United States
(12) Patent Application Publication
(10) Pub. No.: US 2006/0055539 A1
(43) Pub. Date: Mar. 16, 2006

(54) Antennas for radio frequency identification tags in the form of a logo, brand name, trademark, or the like

(76) Inventors: Daniel P. Lawrence, Ann Arbor, MI (US); Michael Fein, Ann Arbor, MI (US); Sayantan Bose, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 11/108,625

(22) Filed: Apr. 18, 2005

Related U.S. Application Data
(60) Provisional application No. 60/608,428, filed on Sep. 9, 2004.

(51) Int. Cl. G08B 13/14; G06K 19/06

(52) U.S. Cl. 340/572.7; 340/572.8; 235/492

(57) ABSTRACT

An RFID antenna or tag is designed to be integrated with artwork such as a logo, brand name, trademark, graphic element, and/or letters. The RFID tag comprises a substrate, which may include or be integrated with a product package. An antenna is formed on the substrate. The antenna includes first and second conductive traces that are integrated with artwork. An integrated circuit is connected across the first and second conductive traces. The conductive traces are integrated with the artwork that is printed on or otherwise integrated with the substrate. At least one of a size, location, and/or gaps between said conductive traces are tuned based on at least on of impedance and radiation pattern thereof.

### CROSS-REFERENCE TO RELATED APPLICATIONS

This application claims the benefit of U.S. Provisional Application No. 60/608,428, filed on Sep. 9, 2004. The disclosure of the above application is incorporated herein by reference.

### FIELD OF THE INVENTION

The present invention relates to antennas, and more particularly to antennas for radio frequency identification (RFID) tags.

### BACKGROUND OF THE INVENTION

Integrated circuits (ICs) are the basic building blocks that are used to create electronic devices. Continuous improvements in IC process and design technologies have led to smaller, more complex, and more reliable electronic devices at a lower cost per function. As performance has increased and size and cost have decreased, the use of ICs has expanded significantly.

One particular type of IC that would benefit from inexpensive mass production involves the use of radio frequency identification (RFID) technology. RFID technology incorporates the use of electromagnetic or electrostatic radio frequency (RF) coupling. Traditional forms of identification such as barcodes, cards, badges, tags, and labels have been widely used to identify items such as access passes, parcels, luggage, tickets, and currencies. However, these forms of identification may not protect items from theft, misplacement, or counterfeit, nor do they allow “touch-free” tracking.

More secure identification forms such as RFID technology offer a feasible and valuable alternative to traditional identification and tracking. RFID does not require physical contact and is not dependent on line-of-sight for identification. RFID technology is widely used today at lower frequencies, such as 13.56 MHz, in security access and animal identification applications. Higher-frequency RFID systems ranging between 850 MHz and 2.5 GHz have recently gained acceptance and are being used in applications such as vehicular tracking and toll collecting, and in business logistics such as manufacturing and distribution.

Antennas for RFID tags are designed primarily to function as collectors of RF energy to promote tag function. RFID tags with traditional antennas are applied inside a package or product, applied underneath a self adhesive label containing graphics, and/or placed on top of the package or product with no attempt at concealment or improving aesthetics.

Inductive coupling, which is used to transfer energy in high frequency (HF) tags at around 13.56 MHz, traditionally use coils of metal. There is little opportunity to adjust the design to fit product aesthetics other than concealment or scaling size. Capacitive coupling usually does not require or benefit from a tuned or specifically shaped antenna to enhance signal strength. Overall antenna area is beneficial for achieving longer read range.

### SUMMARY OF THE INVENTION

An RFID tag comprises a substrate. An antenna is formed on the substrate and includes first and second conductive traces that are integrated with the artwork. An integrated circuit is connected across the first and second conductive traces. The conductive traces of the antenna are integrated with artwork printed on the substrate, wherein at least one of a size, location, and/or gaps between said conductive traces are tuned based on at least one of impedance and radiation pattern thereof.

In another aspect of the invention, a method of integrating a backscatter coupling antenna of an RFID tag in artwork comprises determining attachment point dimensions, an operating frequency, and input impedance of an integrated circuit. Potential attachment gaps in the artwork are identified. Portions of the artwork are identified as potential antenna elements. A first antenna is designed based on the identified potential attachment gaps and the potential antenna elements. The first antenna is tested and/or simulated. At least one of a radiation pattern and/or impedance of the first antenna is identified. At least one second antenna is similarly designed and tested. One of the first and second antennas is selected based on the results.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross sectional view of an RFID antenna;

FIG. 2 illustrate steps of a method for designing an RFID antenna according to the present invention;

FIG. 3 is an exemplary tuned antenna according to the present invention; and

FIG. 4 is another exemplary tuned antenna according to the present invention.

### DETAILED DESCRIPTION OF THE PREFERRED EMBODIMENTS

The following description of the preferred embodiment(s) is merely exemplary in nature and is in no way intended to limit the invention, its application, or uses.

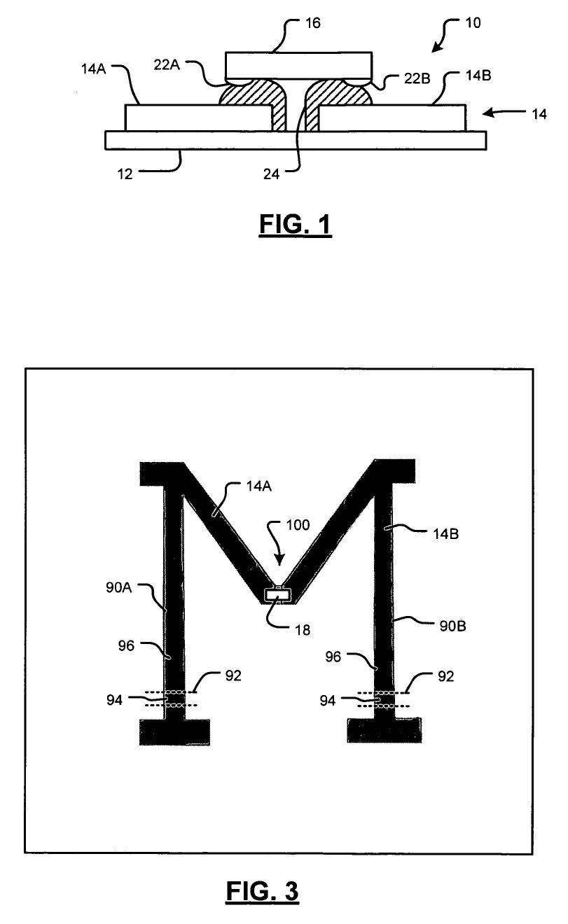

Referring now to FIG. 1, an RFID system 10 includes a substrate 12 having an antenna 14 that is printed thereon and/or otherwise attached thereto. The antenna 14 includes first and second antenna components 14A and 14B. A transmitter is typically implemented using an integrated circuit (IC) 18 and is electronically programmed with a unique identification (ID) and/or information about the item. The IC 18 typically includes conductors 22A and 22B. The conductors 22A and 22B are formed on one side of the IC 18 and are connected by conductive adhesive 24 to the antenna components 14A and 14B, respectively. In use, a transceiver containing a decoder communicates with transmitters that are within range of the RFID system 10. The IC 18 may be connected to one or more antennas 14. Alternatively, the antenna 14 may have more than two antenna components.

The proposed invention accomplishes this with the added benefit of allowing antennas to be designed to have aesthetic value. As used herein, artwork may include, but is not limited to, a logo, brand name, trademark, graphic element, and/or letters. As a result of the present invention, the antenna does not need to be hidden from view and can be a visible, yet functional, component of a product or package. The RFID antenna according to the present invention is tuned to provide enhanced functionality to RFID tags at frequencies from 100 MHz to 100 GHz (preferably from between 840 MHz and 960 MHz to between 2400 and 2500 MHz).

In some embodiments, one or more electrically conductive traces form at least a portion of the artwork. The electrically conductive traces can be the characters or shapes of the artwork itself, and/or the gaps and voids between the shapes or characters. The conductive ink may be transparent and/or colored. Portions of the artwork may be printed using both conductive ink and nonconductive ink having the same color. For example, the letters of a logo or the spaces between the letters can be filled with conductive traces. While conductive ink is described above, the conductive trace can also include foil. The artwork includes at least one conductive trace that extends in at least one dimension. A gap in the conductive trace is formed. The IC is connected across the gap. The input impedance of the antenna at the attachment point is substantially matched to the IC to achieve a reflection coefficient that transmits enough energy to the IC for operation.

In other embodiments, the antenna impedance at the attachment gap is exactly matched to the chip. Conductive traces are printed and/or placed in 2 dimensions. Traces extend in various directions. In some embodiments, conductive traces form an inductive loop in the vicinity of the chip attachment point. In some embodiments, all of the characteristic dimensions are less than ¼wavelength. In other embodiments, at least one characteristic dimension of the conductive trace is greater than or equal to ¼of the intended wavelength of operation. Alternately, multiple characteristic dimensions of the conductive traces are greater than or equal to ¼of the intended wavelength of operation.

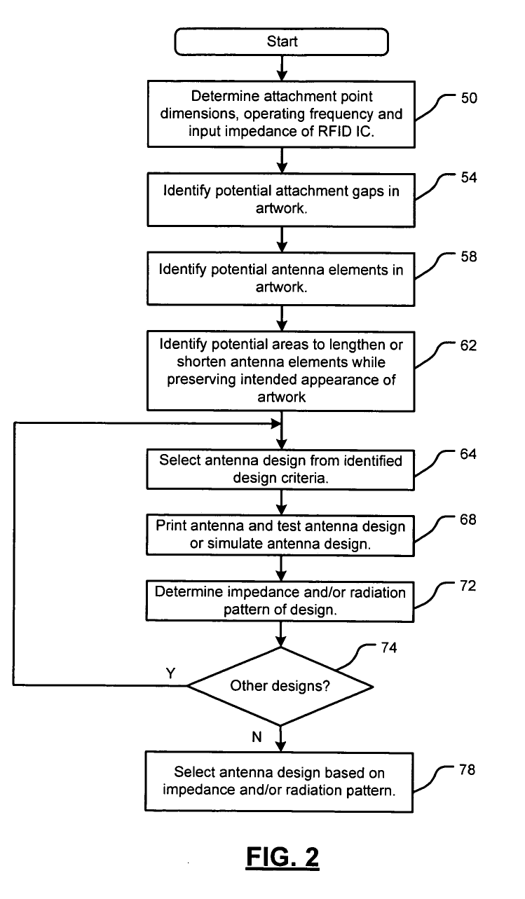

Referring now to FIG. 2, steps of a method according to the present invention are shown. In step 50, attachment point dimensions, operating frequency and input impedance of the IC are determined. One or more possible chip attachment gaps are identified in the artwork in step 54. Potential antenna elements already present within the artwork are identified in step 58. Potential areas for connection of elements to form longer elements and/or potential areas to create gaps within existing elements to form shorter elements are identified in step 62, while preserving the intended appearance of the artwork.

In step 64, antenna design features are selected based on the criteria determined in steps 54-58. In step 68, the antenna is printed and tested or simulated. In step 72, the impedance and/or radiation pattern of the proposed antenna design is measured and/or simulated. In step 74, the process is repeated for other antenna designs. In step 78, the antenna design having a desired impedance and/or radiation pattern is selected.

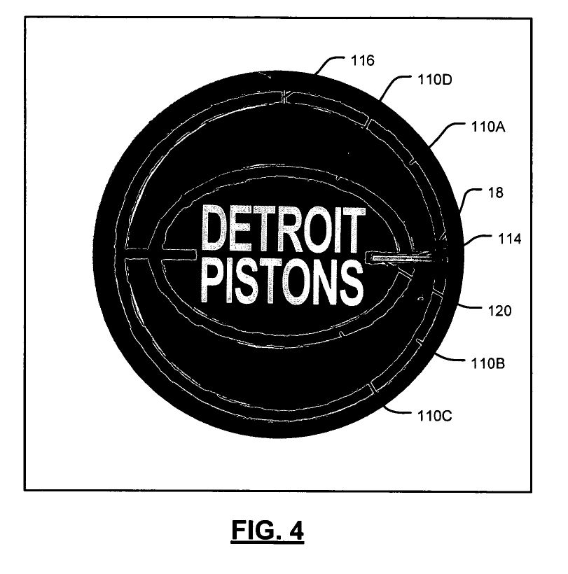

Referring now to FIG. 3, the artwork includes an “M” logo that is defined by first and second conductive traces 90A and 90B having a gap 100 therebetween. The first and second conductive traces 90A and 90B form first and second antenna components 14A and 14B, respectively. The IC 18 spans the gap 100 and is connected thereto by conductive adhesive. One or more additional gaps may be formed in the artwork at 92 with little or no visual impact on the appearance of the logo. For example, non-conductive ink 94 can be used to form the portion of the logo at the gaps 92. The non-conductive ink 94 is the same color as the conductive ink 96 used to form the first and second conductive traces 90A and 90B.

Referring now to FIG. 4, artwork includes a logo that is defined in part by conductive traces 110A, 110B, 110C, and 110D. One or more gaps are defined in the artwork at 114 and 116, with little or no visual impact on the appearance of the logo. An inductive loop 120 is formed near the attachment point of the IC 18, which improves performance in some applications.

In backscatter coupling used in UHF and microwave frequency applications, the primary signal from the reading antenna is reflected by the RFID tag antenna which also modulates it to contain information detectable by the reading antenna. The process steps described herein improve the design of tuned, backscatter, UHF and microwave frequency tags. The present invention allows an antenna to be designed that blends into, mimics, or is concealed by graphics or artwork while maintaining good performance as a receiver, reflector, and transmitter of radio frequency information. These antennas can be manufactured using printing processes, such as, but not limited to: gravure, offset gravure, flexography, offset lithography, letterpress, ink jet, flatbed screen, and/or rotary screen printing. Furthermore, the antenna can be patterned using etching, stamping, or electrochemical deposition (such as electrolysis or electroplating) of metals.

Those skilled in the art can now appreciate from the foregoing description that the broad teachings of the current invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. An RFID tag, comprising:
a substrate;
an antenna formed on said substrate and including first and second conductive traces; and
an integrated circuit that is connected across said first and second conductive traces,
wherein said conductive traces of said antenna are integrated with artwork printed on said substrate, wherein at least one of a size, location, and/or gaps between said conductive traces are tuned based on at least one of an impedance and a radiation pattern of said antenna.

2. The RFID tag of claim 1 wherein said integrated circuit is attached to said conductive traces using conductive adhesive.

3. The RFID tag of claim 1 further comprising a third conductive trace that forms an inductive loop near an attachment location of said integrated circuit.

4. The RFID tag of claim 1 wherein gaps between the first and second conductive traces are integrated with the artwork.

5. The RFID tag of claim 1 wherein the first and second conductive traces are formed from conductive ink.

6. The RFID tag of claim 1 wherein a first portion of at least one of the first and second conductive traces is a first color and second portion of at least one of the first and second conductive traces is a second color.

7. The RFID tag of claim 1 further comprising non-conductive material that is integrated with the first and second conductive traces, wherein the non-conductive material and the first and second conductive traces form the artwork.

8. The RFID tag of claim 7 wherein the non-conductive material is the same color as at least one of the first and second conductive traces.

9. The RFID tag of claim 1 wherein said antenna operates based upon backscatter coupling.

10. The RFID tag of claim 1 wherein an operating frequency of said RFID tag is 100 MHz to 100 GHz.

11. The RFID tag of claim 1 wherein an operating frequency of said RFID tag is between 840 MHz and 960 MHz.

12. The RFID tag of claim 1 wherein an operating frequency of said RFID tag is between 2400 and 2500 MHz.

13. A method of integrating a backscatter coupling antenna of a radio frequency identification (RFID) tag in artwork, comprising:
a) determining attachment point dimensions, an operating frequency and input impedance of an integrated circuit;
b) identifying potential attachment gaps in said artwork;
c) identifying portions of said artwork as potential antenna elements;
d) designing a first antenna based on criteria identified in b) and c);
e) at least one of testing and/or simulating the first antenna of d);
f) determining at least one of a radiation pattern and/or impedance of the first antenna;
g) repeating d), e) and f) for at least one second antenna;
h) selecting one of the first and second antennas.

14. The method of claim 13 further comprising forming an inductive loop adjacent to an attachment point of said integrated circuit.
